(19) United States
(12) Patent Application Publication
(10) Pub. No.: US 2023/0323935 A1
(43) Pub. Date: Oct. 12, 2023

(54) POWERTRAIN FOR ELECTRIC VEHICLE

(71) Applicants: Hyundai Motor Company, Seoul (KR); Kia Corporation, Seoul (KR)

(72) Inventors: Hyu Tae SHIM, Hwaseong-si (KR); Jin Seung LIM, Seoul (KR); Jae Young JEON, Seongnam-si (KR); Jun Seong KANG, Gwacheon-si (KR); Jong Min KIM, Hanam-si (KR); Jae Hun JUNG, Incheon (KR)

(21) Appl. No.: 18/209,833

(22) Filed: Jun. 14, 2023

Related U.S. Application Data
(62) Division of application No. 17/507,481, filed on Oct. 21, 2021.

(30) Foreign Application Priority Data
May 14, 2021 (KR) 10-2021-0062677

(51) Int. Cl. F16H 37/08; B60K 17/16; B60K 17/02; B60K 1/00; B60K 17/08

(52) U.S. Cl. CPC F16H 37/0813; B60K 17/16; B60K 17/02; B60K 1/00; B60K 17/08; F16H 2702/02; B60K 2001/001; F16H 2200/2005; F16H 2200/0034; F16H 2200/0021; F16H 2200/2066; F16H 2200/2064; F16H 2200/2035; F16H 2200/2038; F16H 2200/2082; F16H 2200/2094

(57) ABSTRACT

A powertrain apparatus for an electric vehicle may include a motor connected to an input shaft, a planetary gear train, which is disposed to be coaxial with the motor and which includes a first rotation element, a second rotation element and a third rotation element, at least one of which is configured to receive power from the input shaft, a differential gear disposed to be coaxial with the motor and the planetary gear train, a first gear set connected to one rotation element of the planetary gear train, and a second gear set configured to receive power from the first gear set and transmit the power to the differential gear.

### CROSS-REFERENCE TO RELATED APPLICATION

The present application claims priority to Korean Patent Application No. 10-2021-0062677, filed on May 14, 2021, the entire contents of which is incorporated herein for all purposes by this reference.

### BACKGROUND OF THE INVENTION

### Field of the Invention

The present invention relates to a powertrain apparatus structure for an electric vehicle or the like.

### Description of Related Art

Conventionally, because a powertrain apparatus for an electric vehicle, which is configured to reduce the speed of the power from a motor using external gears and transmit the power to a drive wheel, has at least a triaxial structure, a relatively large space is required to mount the powertrain apparatus in a vehicle, and which is disadvantageous from the aspect of ensuring internal space in a vehicle. Furthermore, it is difficult to satisfy both a desired acceleration performance and the maximum speed performance using only one speed reduction ratio in a high-performance and large-sized vehicle.

The information disclosed in this Background of the present invention section is only for enhancement of understanding of the background of the present invention and may not be taken as an acknowledgement or any form of suggestion that this information forms the prior art already known to a person skilled in the art.

### BRIEF SUMMARY

Various aspects of the present invention are directed to providing a powertrain apparatus for an electric vehicle, which is constructed to have a compact structure to be easily and efficiently mounted in a vehicle, which is advantageous in maximizing available internal space in the vehicle and which is configured for easily realizing desired rapid acceleration performance and maximum speed performance even in a high-performance and large-sized vehicle and of improving efficiency of battery consumption by providing a plurality of changeable speeds.

In accordance with various aspects of the present invention, the above and other objects may be accomplished by the provision of a powertrain apparatus for an electric vehicle including a motor connected to an input shaft, a planetary gear train, which is disposed to be coaxial with the motor and which includes a first rotation element, a second rotation element and a third rotation element, at least one of which is configured to receive power from the input shaft, a differential gear disposed to be coaxial with the motor and the planetary gear train, a first gear set connected to one rotation element of the planetary gear train, and a second gear set configured to receive power from the first gear set and transmit the power to the differential gear.

One of driveshafts, which are coupled to the differential gear, may be coupled to the differential gear through the centers of the planetary gear train, the input shaft and the motor.

The first gear set and the second gear set may be connected to each other via a first pinion and a second pinion, which share the same rotation shaft, the first pinion may form the first external gear set, and the second pinion may form the second external gear set.

The first pinion may be engaged with a drive gear connected to one rotation element of the planetary gear train among the first rotation element, the second rotation element and the third rotation element to form the first external gear set, and the second pinion may be engaged with a differential ring gear of the differential gear to form the second external gear set.

The planetary gear train may be configured such that the first rotation element is fixedly connected to the input shaft, the second rotation element is fixedly connected to the drive gear and is selectively connectable to the input shaft via a first engagement device, and the third rotation element is selectively connectable to a housing via a second engagement device.

The planetary gear train may be configured such that the first rotation element is a sun gear, the second rotation element is a planet carrier, and the third rotation element is a ring gear.

The planetary gear train may be configured such that the first rotation element is a ring gear, the second rotation element is a planet carrier, and the third rotation element is a sun gear.

The first engagement device may be a first clutch, and the second engagement device may be a brake.

The first engagement device may be a first clutch, and the second engagement device may include a one-way clutch and a dog clutch, which are disposed to be parallel to each other.

The planetary gear train may be configured such that the first rotation element is selectively connectable to the input shaft via a first engagement device, the second rotation element is fixedly connected to the drive gear and is selectively connectable to the input shaft via a second engagement device, and the third rotation element is fixed to a housing.

The planetary gear train may be configured such that the first rotation element is a sun gear, the second rotation element is a planet carrier, and the third rotation element is a ring gear.

The planetary gear train may be configured such that the first rotation element is a ring gear, the second rotation element is a planet carrier, and the third rotation element is a sun gear.

The planetary gear train may be configured such that the first rotation element is a planet carrier, the second rotation element is a ring gear, and the third rotation element is a sun gear.

The first engagement device may be a first clutch, and the second engagement device may be a second clutch.

The first engagement device may include a one-way clutch and a dog clutch, and the second engagement device may be a second clutch.

The first engagement device may be a first dog clutch, and the second engagement device may be a second dog clutch.

The planetary gear train may be a double-pinion planetary gear train.

The planetary gear train may be configured such that the first rotation element is fixedly connected to the input shaft, the second rotation element is fixedly connected to the drive gear, and the third rotation element is fixed to a housing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a powertrain apparatus for an electric vehicle according to various exemplary embodiments of the present invention;

FIG. 2 is a view exemplarily illustrating the state in which the power train shown in FIG. 1 is operated to realize a first speed;

FIG. 3 is a view exemplarily illustrating the state in which the power train shown in FIG. 1 is operated to realize a second speed;

FIG. 4, FIG. 5 and FIG. 6 are views exemplarily illustrating modifications of the various exemplary embodiments shown in FIG. 1;

FIG. 7 is a view exemplarily illustrating a powertrain apparatus for an electric vehicle according to various exemplary embodiments of the present invention;

FIG. 8, FIG. 9, FIG. 10, FIG. 11, FIG. 12, FIG. 13, FIG. 14, FIG. 15, FIG. 16, and FIG. 17 are views exemplarily illustrating modifications of the various exemplary embodiments shown in FIG. 7; and

FIG. 18 is a view exemplarily illustrating a powertrain apparatus for an electric vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Specific structural and functional descriptions of embodiments of the present invention disclosed herein are only for illustrative purposes of the exemplary embodiments of the present invention. The present invention may be embodied in various forms, without departing from the spirit and significant characteristics of the present invention. Therefore, the exemplary embodiments of the present invention are disclosed only for illustrative purposes, and should not be construed as limiting the present invention.

Reference will now be made in detail to various embodiments of the present invention, specific examples of which are illustrated in the accompanying drawings and described below, since the exemplary embodiments of the present invention may be variously modified in various forms. While the present invention will be described in conjunction with exemplary embodiments thereof, it is to be understood that the present description is not intended to limit the present invention to those exemplary embodiments. On the other hand, the present invention is directed to cover not only the exemplary embodiments of the present invention, but also various alternatives, modifications, equivalents and other embodiments which may be included within the spirit and scope of the present invention as defined by the appended claims.

It will be understood that, although the terms “first,” “second,” etc. may be used herein to describe various elements, these elements should not be construed as being limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it may be directly coupled or connected to the other element, or intervening elements may be present therebetween. In contrast, it should be understood that when an element is referred to as being “directly coupled” or “directly connected” to another element, there are no intervening elements present. Other expressions that explain the relationships between elements, such as “between,” “directly between,” “adjacent to,” or “directly adjacent to,” should be understood in the same way.

The terminology used herein is for describing various exemplary embodiments only, and is not intended to be limiting. As used herein, the singular forms “a,” “an” and “the” are intended to include the plural forms as well, unless the context clearly indicates otherwise. It will be further understood that the terms “comprise”, “include”, “have”, etc. When used in the exemplary embodiment specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms including technical and scientific terms used herein have the same meaning as those commonly understood by one of ordinary skill in the art to which the present invention belongs. It will be further understood that terms, such as those defined in commonly used dictionaries, should be interpreted as having meanings consistent with their meanings in the context of the relevant art and the present invention, and are not to be interpreted in an idealized or overly formal sense unless expressly so defined herein.

Hereinafter, various exemplary embodiments of the present invention will be described in detail with reference to the accompanying drawings. Throughout the drawings, the same reference numerals will refer to the same or like parts.

In representation of a clutch, a brake or the like, which is an engagement device, in the following embodiments, because there is the housing in which a plurality of clutches are used in various exemplary embodiments of the present invention, the clutches are represented as a first clutch, a second clutch and the like for distinct discrimination between the clutches. In various exemplary embodiments of the present invention, it order to represent the housing in which the first clutch is replaced with another device such as a dog clutch or a one-way clutch, only the second clutch may be represented without representation of the first clutch.

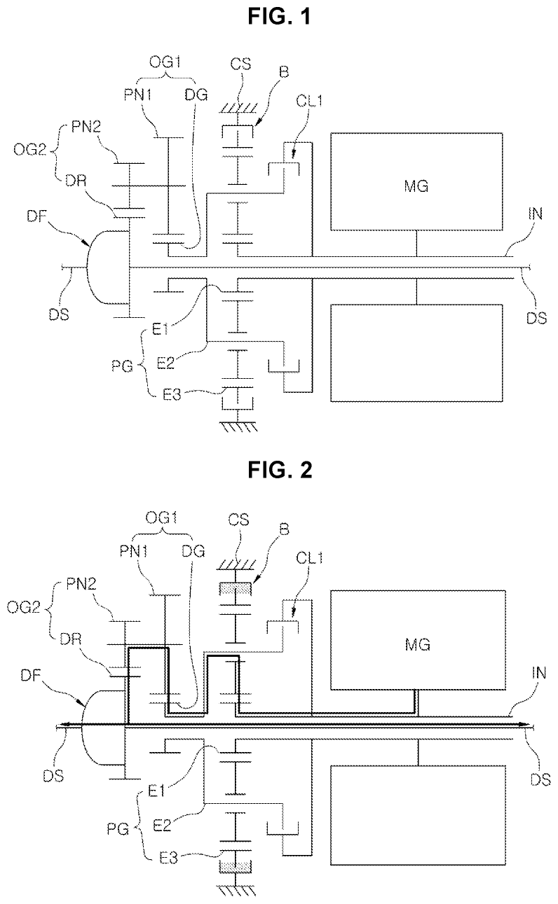

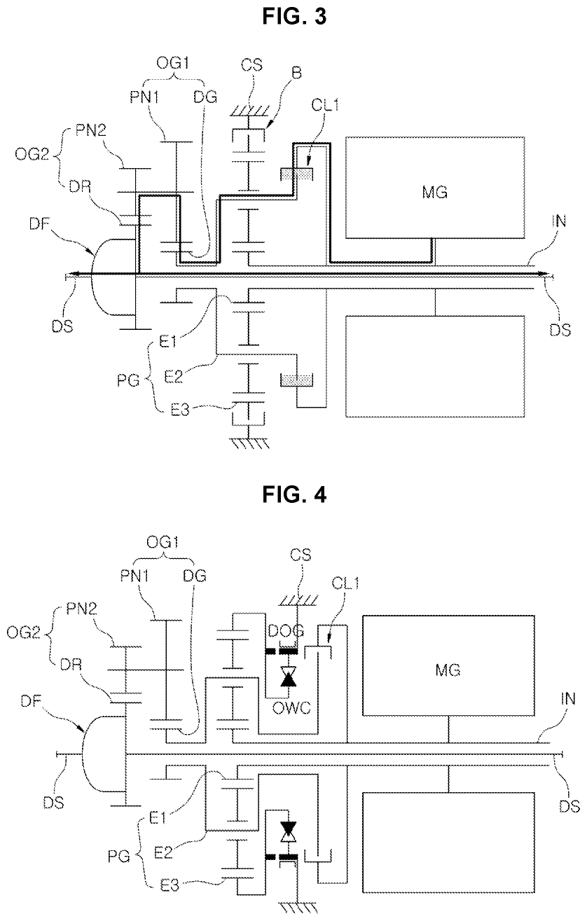

Referring to FIGS. 1 to 18, a powertrain apparatus for an electric vehicle according to exemplary embodiments of the present invention includes a motor MG connected to an input shaft IN, a planetary gear train PG, which is disposed coaxially with the motor MG and which includes a first rotation element E1, a second rotation element E2 and a third rotation element E3 at least one of which is configured to receive the power from the input shaft IN, a differential gear DF, which is disposed coaxially with the motor MG and the planetary gear train PG, a first external gear set OG1 connected to one rotation element of the planetary gear train PG, and a second external gear set OG2 configured to receive the power from the first external gear set OG1, and transmit the power to the differential gear DF.

In other words, the powertrain apparatus for an electric vehicle according to the exemplary embodiments of the present invention is configured to transmit the power, which is supplied to the input shaft IN from the motor MG, to the differential gear OG2 via the planetary gear train PG, the first external gear set OG1 and the second external gear set OG2.

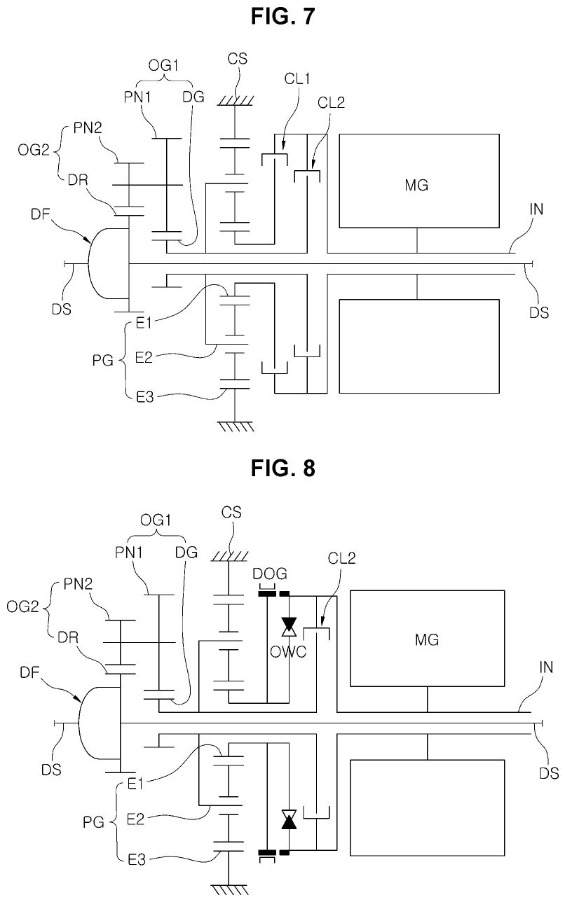

For reference, except for the various exemplary embodiments of the present invention, the various exemplary embodiments shown in FIG. 1 and the various exemplary embodiments shown in FIG. 7 are configured to realize a first speed by transmitting the power from the input shaft IN to the first external gear set OG1 while performing speed reduction and to realize a second speed by transmitting the power from the input shaft IN to the first external gear set OG1 without speed reduction. The powertrain apparatus according to the various exemplary embodiments serves as a simple decelerator.

In the exemplary embodiments of the present invention, one of driveshafts DS is coupled to the differential gear DF through the centers of the planetary gear train PG, the input shaft IN, and the motor MG.

The first external gear set OG1 and the second external gear set OG2 are connected to each other via a first pinion PN1 and a second pinion PN2, which share a single rotation shaft. The first pinion PN1 forms the first external gear set OG1, and the second pinion PN2 forms the second external gear set OG2.

The first pinion PN1 is engaged with a drive gear DG, which is connected to one rotation element of the planetary gear train PG, to form the first external gear set OG1, and the second pinion PN2 is engaged with a differential ring gear DR of the differential gear DF to form the second external gear set OG2.

Accordingly, according to the exemplary embodiments of the present invention, the motor MG, the planetary gear train PG and the differential gear DF are coaxially disposed, and the rotation shaft common to the first pinion PN1 and the second pinion PN2 is disposed to be parallel to the rotation shafts of the motor MG, the planetary gear train PG and the differential gear DF, realizing a biaxial structure. Consequently, since the powertrain apparatus is configured to be compact, the powertrain apparatus is easily and efficiently mounted in a vehicle, which is advantageous in ensuring internal space in the vehicle. Furthermore, since two changeable speeds are realized, it is possible to realize rapid acceleration performance and maximum speed performance relatively easily even in a high-performance and large-sized vehicle, and it is also possible to improve electric mileage.

The above-described configuration is common to all of the exemplary embodiments of the present invention. In the various exemplary embodiments shown in FIG. 1, the planetary gear train PG is configured such that the first rotation element E1 is directly connected to the input shaft IN, the second rotation element E2 is directly connected to the drive gear DG and is selectively connectable to the input shaft IN via a first engagement device, and the third element E3 is fixedly coupled to a housing CS via a second engagement device.

Here, the first rotation element E1 of the planetary gear train PG may be thought of as a sun gear, the second rotation element E2 may be thought of as a planet carrier, and the third rotation element E3 may be thought of as a ring gear. As illustrated in FIG. 2, when the ring gear is fixed to the housing CS by the brake B in the state in which the power from the motor MG is input to the sun gear, which is connected to the input shaft IN, the power input to the sun gear is reduced in speed by the planet carrier, and is transmitted to the first pinion PN1 via the drive gear DG.

The power supplied to the planetary gear train PG from the motor MG is reduced in speed and transmitted to the drive gear DG. Subsequently, the power is further reduced in speed through the first external gear set OG1 and the second external gear set OG2 and is transmitted to the two driveshafts DS via the differential gear DF, transmitting a first-speed power to a drive wheel connected to the driveshaft DS.

When the first clutch CL1 is engaged in the state in which the brake B is disengaged, the power from the input shaft IN is directly transmitted to the drive gear DG without being subjected to speed reduction through the planetary gear train PG, and is then transmitted to the drive wheel as a second-speed power through the first external gear set OG1, the second external gear set OG2, and the differential gear DF in that order.

In the various exemplary embodiments of the present invention, the first engagement device is embodied as the first clutch CL1, and the second engagement device is embodied as the brake B.

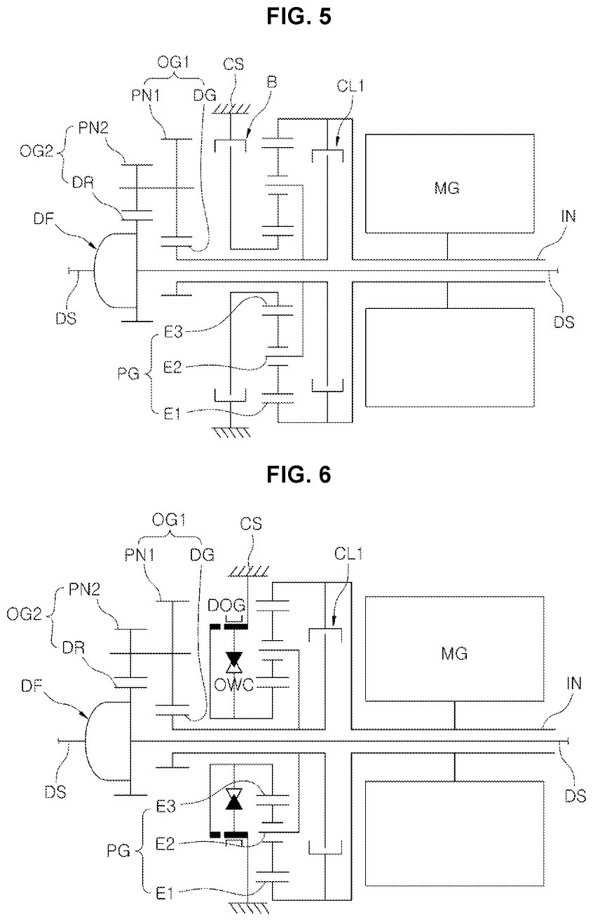

FIG. 4 illustrates a modification of the various exemplary embodiments shown in FIG. 1. In the modification, the planetary gear train PG is configured such that the first rotation element E1 is directly connected to the input shaft IN, the second rotation element E2 is directly connected to the drive gear DG and is selectively connectable to the input shaft IN via the first clutch CL1, which is configured as the first engagement device, and the third rotation element E3 is fixedly coupled to the housing CS via a one-way clutch OWC and a dog clutch DOG, which serve as the second engagement device.

In the exemplary embodiment of the present invention, the brake B, which is the second engagement device according to the various exemplary embodiments of the present invention, is replaced with a one-way clutch OWC and a dog clutch DOG, which are disposed to be parallel to each other.

For reference, the dog clutch DOG is a different dog clutch, which is distinguished from a first dog clutch D1 and a second dog clutch D2 according to other embodiments, which will be described later.

FIG. 5 illustrates another modification of the various exemplary embodiments shown in FIG. 1. The present modification is substantially identical to the various exemplary embodiments of the present invention, with the exception that the first rotation element E1 of the planetary gear train PG is a ring gear, the second rotation element E2 is a planet carrier, and the third rotation element E3 is a sun gear.

FIG. 6 illustrates a further modification of the various exemplary embodiments. The present modification is substantially identical to the modification shown in FIG. 4, with the exception that the first rotation element E1 of the planetary gear train PG is a ring gear, the second rotation element E2 is a planet carrier, and the third rotation element E3 is a sun gear.

Referring to FIG. 7, the powertrain apparatus for an electric vehicle according to various exemplary embodiments of in various aspects of the present invention, the first rotation element E1 of the planetary gear train PG is selectively connectable to the input shaft IN via the first engagement device, the second rotation element E2 is directly connected to the drive gear DG and is selectively connectable to the input shaft IN via the second engagement device, and the third rotation element E3 is fixed to the housing CS.

In the planetary gear train PG, the first rotation element E1 is a sun gear, the second rotation element E2 is a planet carrier, and the third rotation element E3 is a ring gear. Here, the first engagement device is the first clutch CL1 and the second engagement device is the second clutch CL2.

Because the various exemplary embodiments are configured such that the ring gear, which is the third rotation element E3, is fixed to the housing CS, when the first clutch CL1, which is the first engagement device, is engaged, the power, which is input to the sun gear, which is the first rotation element E1, from the motor MG, is reduced in speed through the planet carrier, which is the second rotation element E2, and is transmitted to the drive gear DG, realizing the first speed.

Meanwhile, when the first clutch CL1, which is the first engagement device, is disengaged while the second clutch CL2, which is the second engagement device, is engaged, the power, which is transmitted to the input shaft IN from the motor MG, is directly transmitted to the drive gear DG, realizing the second speed.

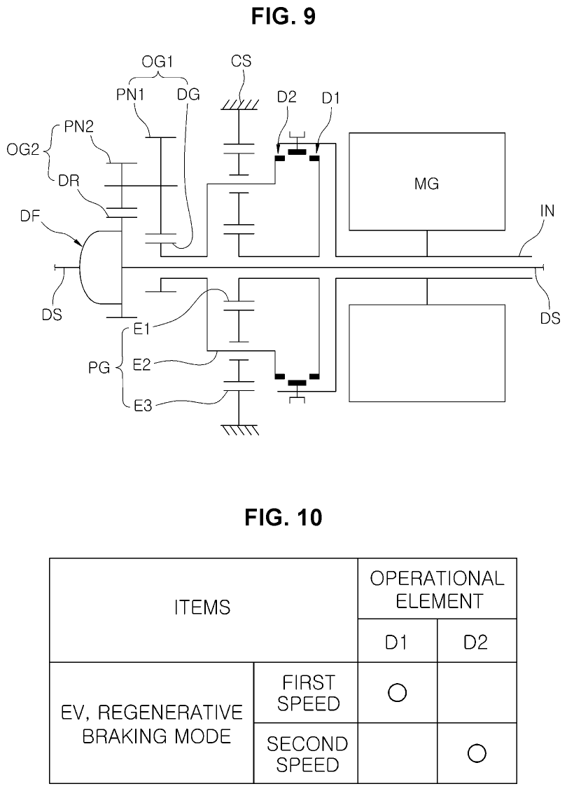

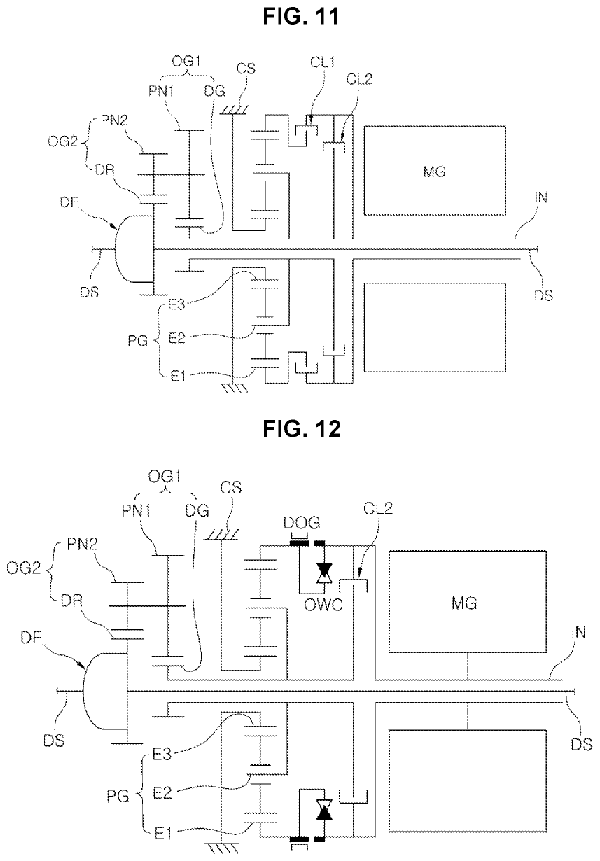

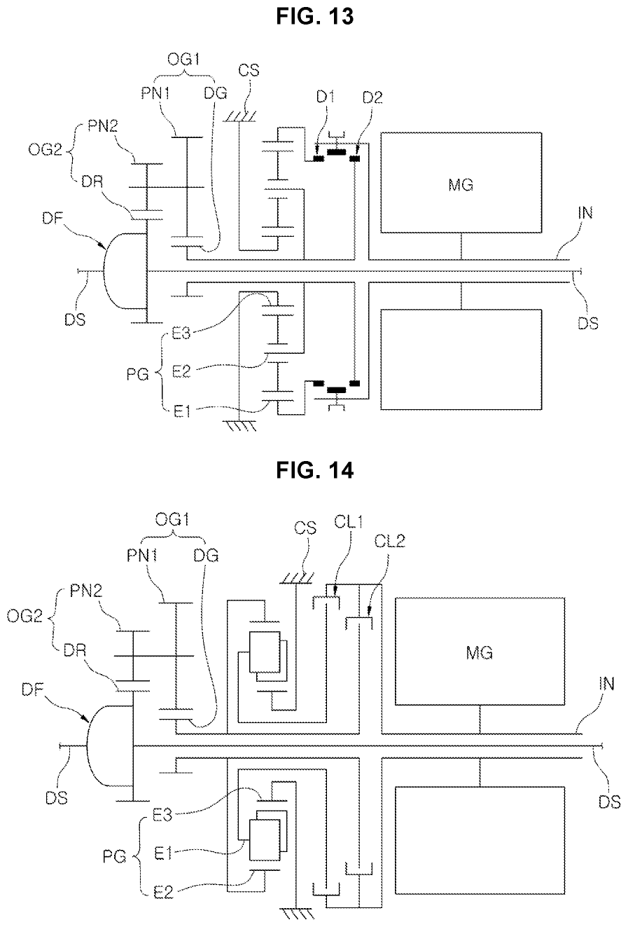

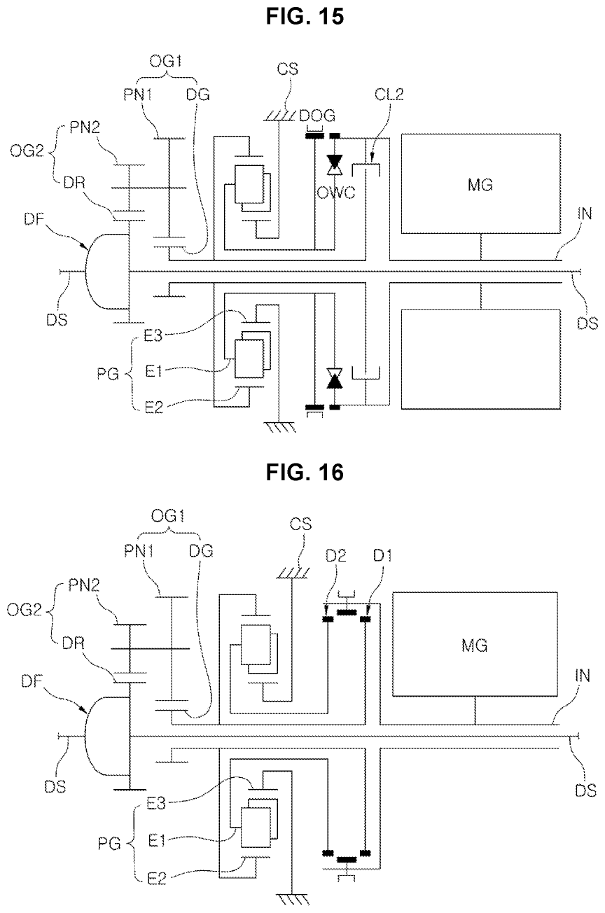

FIG. 8 illustrates a modification of the various exemplary embodiments shown in FIG. 7. The present modification is substantially identical to the various exemplary embodiments of the present invention, with the exception that the first engagement device is replaced with a one-way clutch OWC and a dog clutch DOC, which are disposed to be parallel to each other.

FIG. 9 illustrates another modification of the various exemplary embodiments shown in FIG. 7. The present modification is substantially identical to the various exemplary embodiments of the present invention, with the exception that the first engagement device and the second engagement device are respectively replaced with a first dog clutch D1 and a second dog clutch D2. FIG. 10 is an operational mode table for the exemplary embodiment shown in FIG. 9.

FIG. 11 illustrates yet another modification of the various exemplary embodiments shown in FIG. 7. The present modification is substantially identical to the various exemplary embodiments of the present invention, with the exception that the first rotation element E1 of the planetary gear train PG is a ring gear, the second rotation element E2 is a planet carrier, and the third rotation element E3 is a sun gear.

FIG. 12 illustrates yet another modification of the various exemplary embodiments shown in FIG. 7. In the present modification, the first engagement device according to the modification shown in FIG. 11 is replaced with a one-way clutch OWC and a dog clutch DOC, which are disposed to be parallel to each other.

FIG. 13 illustrates still yet another modification of the various exemplary embodiments shown in FIG. 7. In the present modification, the first engagement device and the second engagement device according to the modification shown in FIG. 11 are respectively replaced with a first dog clutch D1 and a second dog clutch D2.

FIG. 14 illustrates a further modification of the various exemplary embodiments shown in FIG. 7. In the present modification, the planetary gear train PG according to the various exemplary embodiments are embodied as a double-pinion planetary gear train. Here, the first rotation element E1 is a planet carrier, the second rotation element E2 is a ring gear, and the third rotation element E3 is a sun gear. Furthermore, the first engagement device is a first clutch CL1, and the second engagement device is a second clutch CL2.

FIG. 15 illustrates still a further modification of the various exemplary embodiments shown in FIG. 7. In the present modification, the first engagement device according to the modification shown in FIG. 14 is replaced with a one-way clutch OWC and a dog clutch DOC, which are disposed to be parallel to each other.

FIG. 16 illustrates yet a further modification of the various exemplary embodiments shown in FIG. 7. In the present modification, the first engagement device and the second engagement device according to the modification shown in FIG. 14 are respectively replaced with a first dog clutch D1 and a second dog clutch D2.

FIG. 17 illustrates still yet a further modification of the various exemplary embodiments shown in FIG. 7. In the present modification, the relative position between the first clutch CL1, which is the first engagement device, and the second clutch CL2, which is the second engagement device, in the axial direction is changed.

As described above, the various exemplary embodiments and the various exemplary embodiments of the present invention are able to provide a vehicle with a transmission gear ratio between two speeds through the first engagement device and the second engagement device.

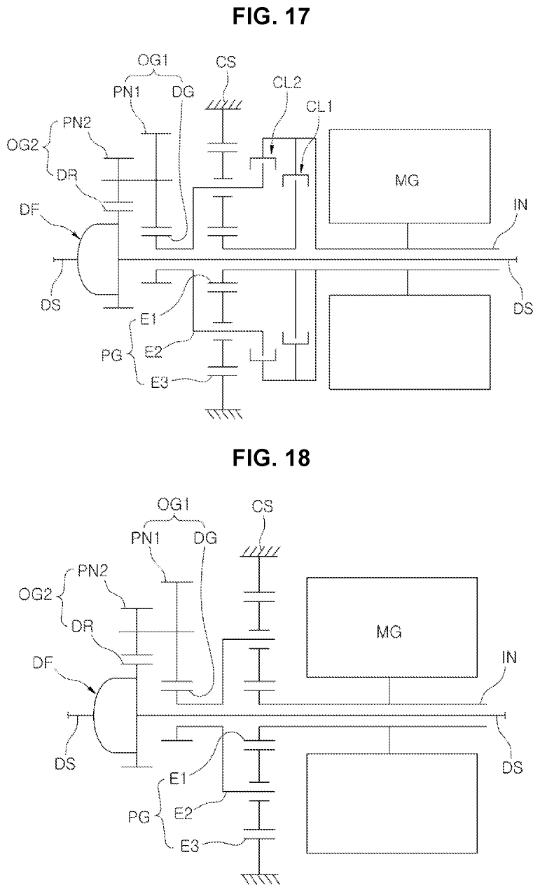

FIG. 18 illustrates a simple decelerator according to various exemplary embodiments of the present invention. Here, the planetary gear train PG is configured such that the first rotation element E1 is directly connected to the input shaft IN, the second rotation element E2 is directly connected to the drive gear DG, and the third rotation element E3 is fixed to the housing CS.

Consequently, the power transmitted to the input shaft IN from the motor MG is input to the sun gear, which is the first rotation element E1, reduced in speed through the planet carrier, which is the second rotation element E2, and transmitted to the drive gear DG. The power transmitted to the drive gear DG, is transmitted to the differential ring gear DR via the first pinion PN1 and the second pinion PN2 to drive the differential gear DF. The two driveshafts DS, which are connected to the differential gear DF, transmit the power transmitted to the differential gear DF to the two drive wheels.

The present exemplary embodiment confers an advantage in that the power from the motor is subjected to speed reduction while being transmitted through the planetary gear train PG, the first external gear set OG1 and the second external gear set OG2 in that order, making it possible to realize a high speed-reduction ratio in a relatively small space.

As is apparent from the above description, the powertrain apparatus of the present invention is constructed to have a compact structure to be easily and efficiently mounted in a vehicle, which is advantageous in ensuring internal space in the vehicle. Furthermore, Since various aspects of the present invention are directed to providing a plurality of changeable speeds, it is possible to easily realize desired rapid acceleration performance and maximum speed performance even in a high-performance and large-sized vehicle, and it is possible to improve electric mileage.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

1. A powertrain apparatus for a vehicle, the powertrain apparatus comprising:
a motor connected to an input shaft;
a planetary gear train, which is disposed to be coaxial with the motor and which includes a first rotation element, a second rotation element and a third rotation element, at least one of which is configured to receive power from the input shaft;
a differential gear disposed to be coaxial with the motor and the planetary gear train;
a first gear set connected to one rotation element of the planetary gear train among the first rotation element, the second rotation element and the third rotation element; and
a second gear set configured to receive power from the first gear set and transmit the power to the differential gear.

2-19. (canceled)

20. A powertrain apparatus for a vehicle, the powertrain apparatus comprising:
a motor connected to an input shaft;
a planetary gear train, which is disposed to be coaxial with the motor and which includes a first rotation element, a second rotation element and a third rotation element, at least one of which is configured to receive power from the input shaft;
a differential gear disposed to be coaxial with the motor and the planetary gear train;
a first gear set connected to one rotation element of the planetary gear train among the first rotation element, the second rotation element and the third rotation element; and
a second gear set configured to receive power from the first gear set and transmit the power to the differential gear,
wherein one of driveshafts is coupled to the differential gear through centers of the planetary gear train, the input shaft and the motor,
wherein the first gear set includes a first pinion and the second gear set includes a second pinion and the first gear set and the second gear set are connected to each other via the first pinion and the second pinion, which share a same rotation shaft,
wherein the first gear set further includes a drive gear connected to one rotation element of the planetary gear train among the first rotation element, the second rotation element and the third rotation element and the first pinion is engaged with the drive gear,
wherein the second gear set further includes a differential ring gear of the differential gear and the second pinion is engaged with the differential ring gear of the differential gear, and
wherein the first rotation element is fixedly connected to the input shaft, the second rotation element is fixedly connected to the drive gear, and the third rotation element is fixed to a housing.
